(19) United States
(12) Patent Application Publication
(10) Pub. No.: US 2016/0079762 A1
(43) Pub. Date: Mar. 17, 2016

(54) PLIABLE OBJECT HAVING LOW-PROFILE POWER-COUPLING TRANSMISSION MODULE

(71) Applicant: COREMATE TECHNICAL CO., LTD., TAOYUAN COUNTY (TW)

(72) Inventor: Robert WANG, TAOYUAN COUNTY (TW)

(21) Appl. No.: 14/487,278

(22) Filed: Sep. 16, 2014

(51) Int. Cl. H02J 5/00

(52) U.S. Cl. CPC H02J 5/005

(57) ABSTRACT

A pliable object having a low-profile power-coupling transmission module is disclosed. The pliable object has a pliable body. A secondary induction module fixed to the pliable body is electrically connected to an acting member. The secondary induction module is flexible. The pliable body has a receiving pocket corresponding to the secondary induction module for receiving a primary inductive power module. Thereby, when the primary inductive power module is placed in the receiving pocket, electromagnetic coupling thus established can power the acting member to function. With the flexibility, the present invention is crushproof, shatterproof and bend-proof.

### BACKGROUND OF THE INVENTION

1. Technical Field

The present invention relates to electric power transmission modules, and more particularly to a pliable object having a low-profile power-coupling transmission module.

2. Description of Related Art

As referred to herein, a pliable object means an object made of fabric or nylon fiber, such as a human wearable article, an umbrella, a tent, etc. Some of such objects are desired to provide lighting, heating and/or cooling functions for the users' safety and comfort. In order to endow a pliable object with any of the lighting, heating and cooling functions, the installation of an electronic device is indispensible. Such an electronic device is usually powered by electricity from a mobile power bank or something alike. As known, a mobile power bank is a device storing power and acting as an on-the-go charger so that its user is freed from the trouble finding a wall socket anywhere when the power in his/her mobile device is running low. The mobile power bank is also advantaged by the fact that the mobile device getting charged can be moved instead of being stuck to the immovable wall socket. It has been seen that some manufacturers combine a mobile power bank with a pliable object that is equipped with an electronic device. In these combinations, the pliable object has its electronic device electrically connected to the mobile power bank through a conducting wire, so that the electronic device is enabled to receive power from the mobile power bank and provide its intended function(s). However, since the pliable object is something subject to users' wear, to water wash, to the weather and to pulling, dragging and bending, its parts and/or welds connecting to or from the electronic device tend to be wetted or damaged. In this case, once the electronic device is electrified by the mobile power bank, a risk of a short circuit and even fire appears. Furthermore, currently, the connection between the mobile power bank and the device to be charged can only be established using a transmission cord. That means once the user leaves the cord behind or loses it outside, the desired charging becomes impossible, which is very inconvenient.

For improving the shortcomings related to the existing mobile power bank as discussed above, some manufacturers have developed wireless charging devices. Such a wireless charging device is typically constructed from a coil module having copper windings and a charging module fixed to a rigid substrate, and provides charging functions using electromagnetic induction. However, the brittle and inflexible substrate makes the overall charging module bulky and space-consuming, and likely to break apart when being accidentally fallen or receiving impacts and lose its charging function. In view of the shortcomings of the prior-art devices, the inventor of the present invention has made improvements thereto and developed a pliable sensing board for wireless power transmission. The pliable sensing board has its components made of pliable materials, so the whole assembly is flexible and unbreakable. Nevertheless, its charging function still requires an external power source, making it somehow inconvenient to users. With this observation, the inventor of the present invention recognizes the needs for further improving the known mobile power banks, pliable objects having electronic devices, and pliable sensing boards for wireless charging and provides a novel device herein.

### SUMMARY OF THE INVENTION

The primary objective of the present invention is to provide a pliable object having a low-profile power-coupling transmission module, which realizes wireless power supply while being low profile and unbreakable. As the power-coupling transmission module is made of a pliable material, it can be applied to various pliable objects and is advantageously crushproof, shatterproof, bend-proof, waterproof and sealing. For achieving the objective, the disclosed pliable object comprises: a pliable body, having a fixing portion and a receiving pocket both at an identical side of the pliable body; a primary inductive power module, having a battery connected to a primary induction coil that has concentric windings, and having a primary induction patch that is deposited at one side of the primary induction coil and is flexible and effective in shielding permeance and isolating magnetic fields, and being received in the receiving pocket; a secondary induction module, being fixed to the fixing portion of the pliable body, having a secondary induction patch that is flexible and effective in shielding permeance and isolating magnetic fields, a secondary induction coil that is at the same side of the secondary induction module with the secondary induction patch and has concentric windings, and an acting member deposited on the pliable body and electrically connected to the secondary induction coil.

In the disclosed pliable object, the secondary induction module is fixed to the fixing portion of the pliable body and is electrically connected to the secondary induction module. When using it, a user may place the primary inductive power module into the receiving pocket of the pliable body, and align the primary inductive power module with the secondary induction module, so that magnetic coupling is established between the primary induction coil and the secondary induction coil, allowing the power in the battery to be transmitted to the secondary induction coil through the primary induction coil in a wireless manner, thereby powering the acting member to function as intended. Thus, the present invention realizes wireless power supply using the primary inductive power module and the secondary induction module, and endows the device with a lower profile, while speeding up wireless power transmission as compared to the prior art. Additionally, since the secondary induction module is flexible, it is applicable to various pliable object without the concern of breakage while being advantageously crushproof, shatterproof, bend-proof, waterproof and sealing.

### BRIEF DESCRIPTION OF THE DRAWINGS

FIG. 1 is an exploded view of a primary inductive power module according to a first preferred embodiment of the present invention.

FIG. 2 is an exploded view of a secondary inductive battery module according to the first preferred embodiment of the present invention.

FIG. 3 and FIG. 4 are applied views of the first preferred embodiment of the present invention.

FIG. 5 is a schematic drawing illustrating magnetic coupling realized by the first preferred embodiment of the present invention.

FIG. 6 is an applied view of a second embodiment of the present invention.

FIG. 7 is an applied view of a third embodiment of the present invention.

FIG. 8 is an applied view of a fourth embodiment of the present invention.

### DETAILED DESCRIPTION OF THE INVENTION

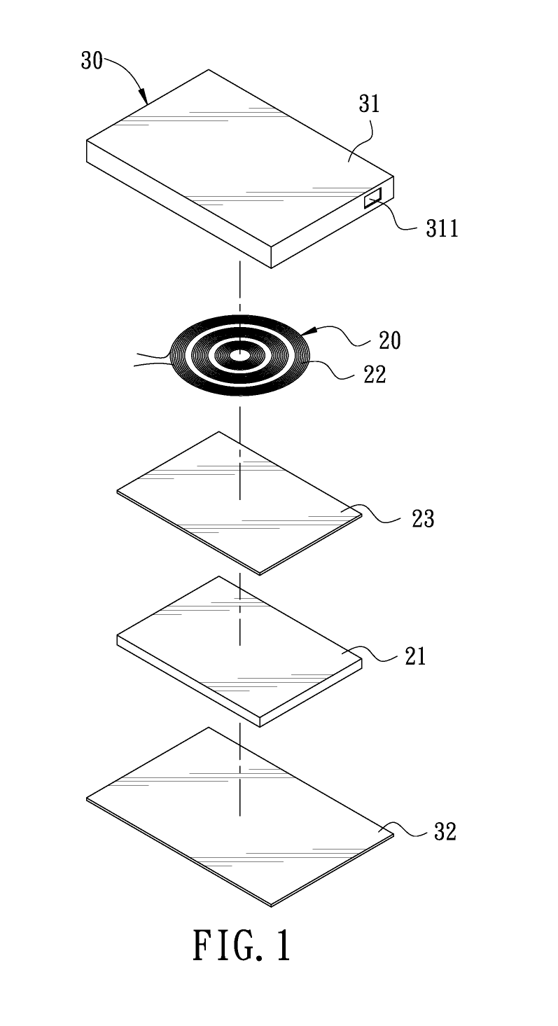

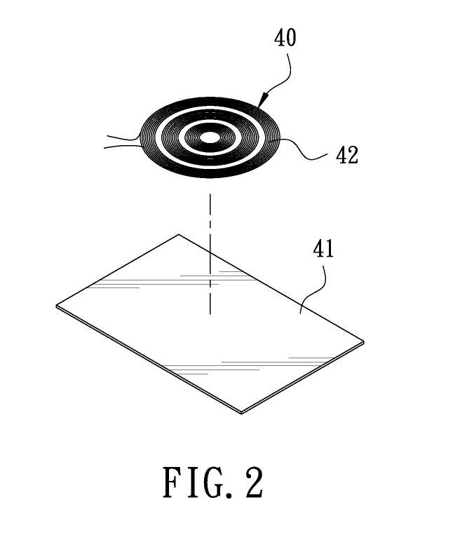

FIG. 1 and FIG. 2, according to a first preferred embodiment of the present invention, depict a primary inductive power module and a secondary inductive battery module of a pliable object having a low-profile power-coupling transmission module. The pliable object comprises a pliable body 10, the primary inductive power module 20, a casing 30, the secondary induction module 40, and an acting member 50.

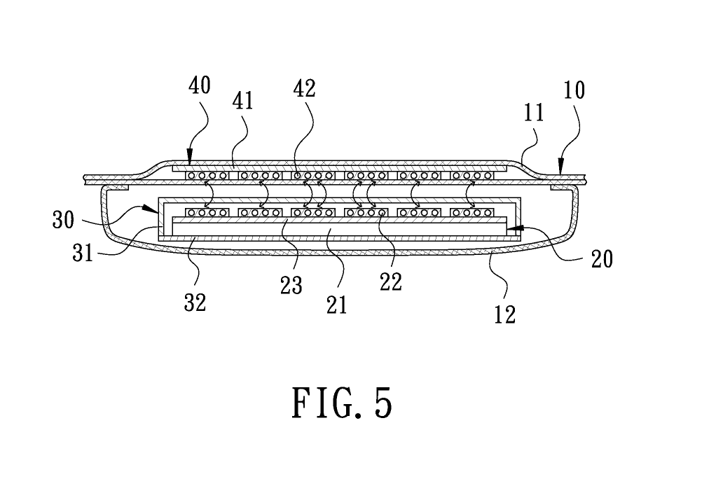

The pliable body 10, as also shown in FIG. 5, has a fixing portion 11. The pliable body 10 at a side having the fixing portion 11 is provided with a receiving pocket 12. In the present embodiment, the pliable body is a pliable object selected from the group at least consisting of a wearable article, a curtain, an umbrella and a tent.

The primary inductive power module 20 has a battery 21. The battery 21 is connected to a primary induction coil 22. The primary induction coil 22 has concentric windings. A primary induction patch 23 is provided at one side of the primary induction coil 22. In the present embodiment, the primary induction patch 23 is a flexible, pliable sheet in the form of a spacing member, a shielding member or a separating member. The primary induction patch 23 is made of iron powder cement and aluminum. The iron powder cement has permeability, and is resistant to electromagnetic interference and to magnetic leakage, while aluminum is effective in isolating magnetic fields.

The casing 30, as shown in FIG. 1 as well as FIG. 5, has an upper cover 31 and a lower cover 32. The casing 30 contains therein the primary inductive power module 20. A socket 311 is provided at one side of the upper cover 31 and is electrically connected to the battery 21. In the present embodiment, the primary induction coil 22 is located near the upper cover 31.

The secondary induction module 40 is fixed to the fixing portion 11 of the pliable body 10, and includes a secondary induction patch 41. The secondary induction module 40 has a secondary induction coil 42 at one side of the secondary induction patch 41. The secondary induction coil 42 has concentric windings. In the present embodiment, the secondary induction patch 41 is a flexible, pliable sheet in the form of a spacing member, a shielding member or a separating member. The secondary induction patch 41 is made of iron powder cement and aluminum. The iron powder cement has permeability, and is resistant to electromagnetic interference and to magnetic leakage, while aluminum is effective in isolating magnetic fields.

The acting member 50 is deposited on the pliable body 10 and electrically connected to the secondary induction coil 42. In the present embodiment, the acting member 50 is one driven by electric power such as an LED lamp, sound-giving member, a fan, a sensor, etc.

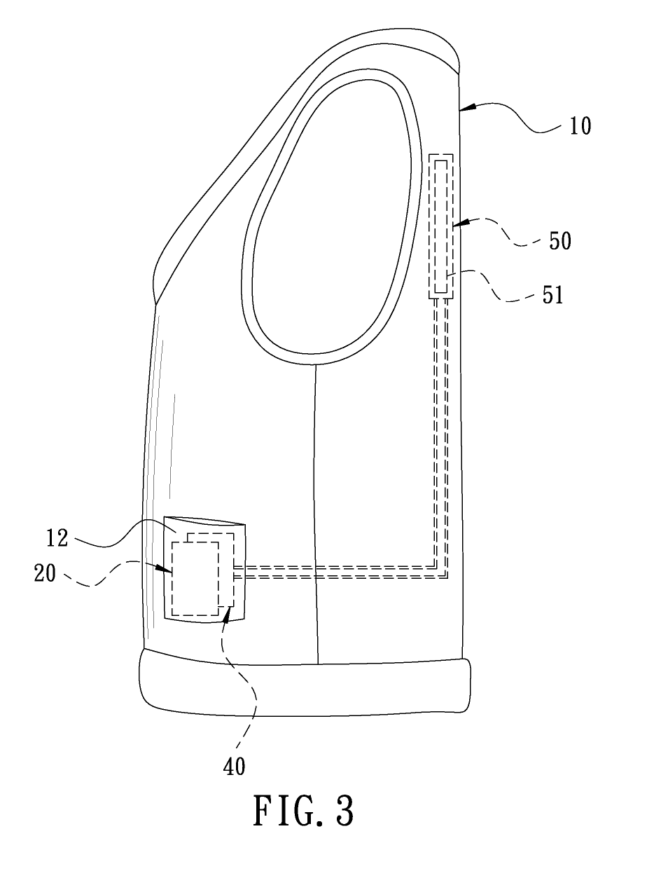

Please refer to FIG. 3 as well as FIG. 5, which are the applied view of the first preferred embodiment of the present invention and the schematic drawing illustrating magnetic coupling realized by the first preferred embodiment of the present invention. Since the secondary induction module 40, is fixed to the fixing portion 11 of the pliable body 10 and is electrically connected to the acting member 50, a user using the subject matter of the present invention can place the primary inductive power module 20 in the receiving pocket 12 of the pliable body 10, and align the primary inductive power module 20 with the secondary induction module 40, so that magnetic coupling is established between the primary induction coil 22 and the secondary induction coil 40, allowing the power in the battery 21 to be transmitted to the secondary induction coil 42 through the primary induction coil 22 in a wireless manner, thereby powering the acting member 50 to function as intended. Additionally, the secondary induction module 40 and the acting member 50 may be coated with waterproof glue for being resistant to moisture. Thereby, the present invention realizes wireless power supply using the primary inductive power module 20 and the secondary induction module 40, and endows the device with a lower profile, while speeding up wireless power transmission as compared to the prior art. Additionally, since the secondary induction module 40 is flexible, it is applicable to various pliable object without the concern of breakage while being advantageously crushproof, shatterproof, bend-proof, waterproof and sealing. At last, the primary inductive power module 20 may be in the form of a portable wireless inductive battery, and can be used to charge other external electric appliances, thereby enhancing its convenience.

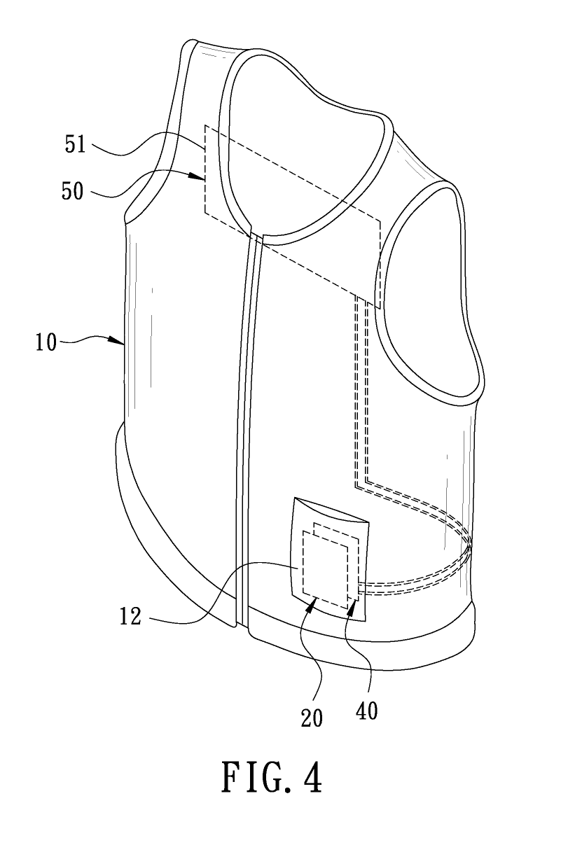

Referring to FIG. 3 and FIG. 4 as well as FIG. 5 for the applied views of the present invention first preferred embodiment and the magnetic coupling. The pliable body 10 is a vest-type jacket, and the acting member 50 is an object having intended function(s), such as a lighting device, a cooling device, or a heating device. In the present embodiment, the acting member 50 is a lighting device 51. When using the inventive article, a user may place the primary inductive power module 20 in the receiving pocket 12 of the pliable body 10, and align the primary induction coil 22 with the secondary induction coil 42 so as to establish electromagnetic coupling that allows the acting member 50 to be powered and function, thereby enabling the vest-type jacket to give out warning light. Such a jacket is particularly usable at night for ensuring a pedestrian's safety. Moreover, the present invention has the primary induction patch 23 and the secondary induction patch 41 made of the selected flexible materials, so overall weight and volume of the device can be minimized, making it more portable and convenient.

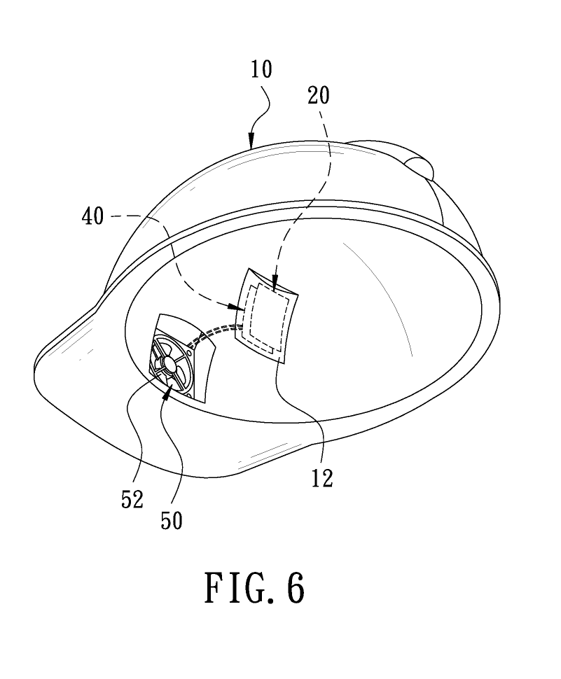

Referring to FIG. 6, a second embodiment of the present invention is depicted. The present embodiment is different from the first preferred embodiment by that the pliable body 10 is in the form of a hat, and the acting member 50 is a fan 52. The acting member 50 is installed on the body of hat. Also referring to FIG. 5, when using the inventive article, a user may place the primary inductive power module 20 in the receiving pocket 12 of the pliable body 10, and align the primary induction coil 22 with the secondary induction coil 42, so as to establish electromagnetic coupling and power the fan 52 to operate, thereby achieving heat dissipation. Thus, the primary inductive power module 20 and the secondary induction module 40 of the present invention can be applied to various kinds of pliable objects, making the present invention more adaptable.

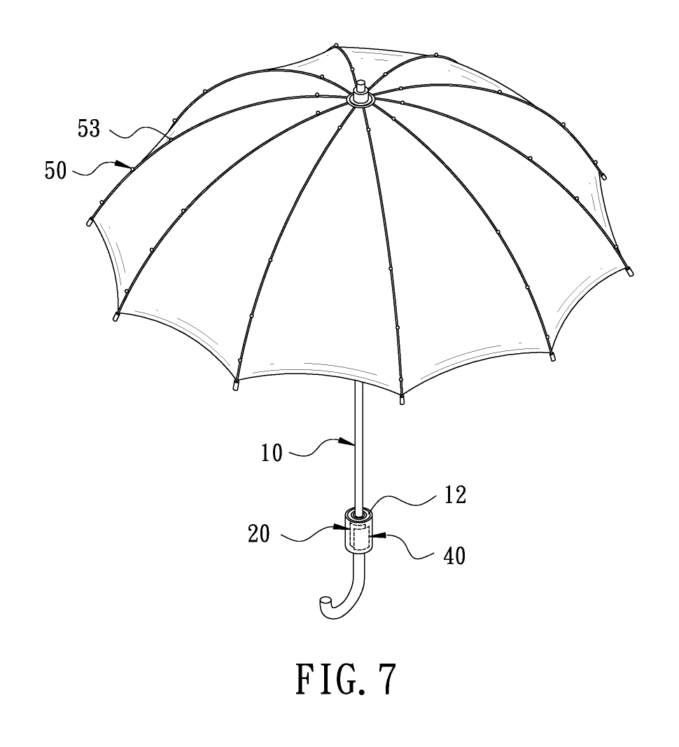

Now please refer to FIG. 7 for a third embodiment of the present invention. The present embodiment is different from the first preferred embodiment by that the pliable body 10 is in the form of an umbrella and the acting member 50 includes plural LED lamps 53. The LED lamps 53 are installed on the ribs of the umbrella, and the receiving pocket 12 of the pliable body 10 is deposited at grip of the umbrella. Also referring to FIG. 5, similar to the first preferred embodiment, when used, the primary inductive power module 20 is placed in the receiving pocket 12 of the pliable body 10, and the primary induction coil 22 is aligned with the secondary induction coil 42, so as to establish electromagnetic coupling and power the LED lamps 53 to illuminate, thereby ensuring the traffic safety of a pedestrian holding such an umbrella.

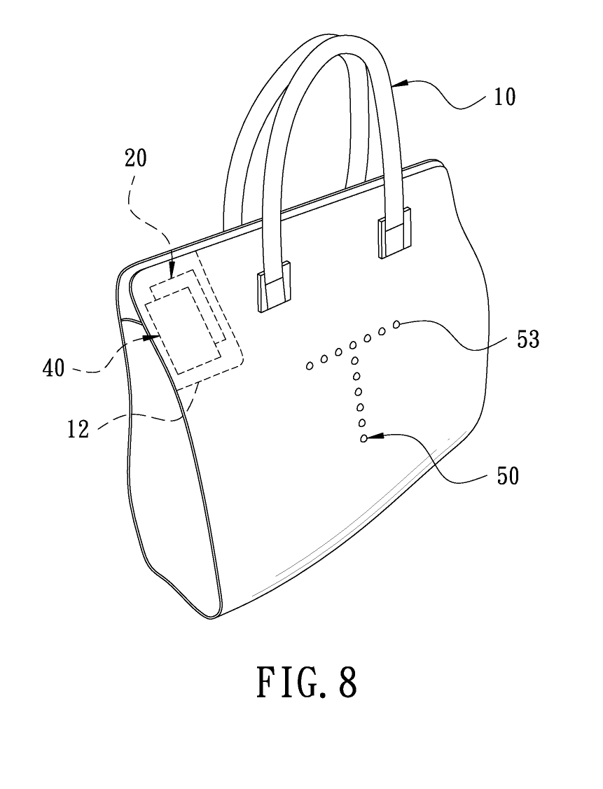

FIG. 8 illustrates an application of the present invention as the fourth embodiment. The present embodiment is different from the first preferred embodiment by that the pliable body 10 is in the form of a shoulder bag, and the acting member 50 includes plural LED lamps 53. The LED lamps 53 are arranged at one side of the shoulder bag to form a character denoting the brand of the shoulder bag or a decorative pattern. In the shown embodiment, the LED lamps are arranged into a letter denoting the brand of the shoulder bag. The receiving pocket 12 of the pliable body 10 is provided inside the shoulder bag. Also referring to FIG. 5, similar to the first preferred embodiment, when used, the primary inductive power module 20 is placed in the receiving pocket 12 of the pliable body 10, and the primary induction coil 22 is aligned with the secondary induction coil 42, so as to establish electromagnetic coupling and power the LED lamps 53 to illuminate. Thereby, when a pedestrian carrying the bag walk along the street at night, the illuminating LED lamps 53 can visually warn other pedestrians and motor vehicles of the presence of the pedestrian, thereby ensuring the user's safety.

It is to be noted that, when the battery 21 of the primary inductive power module 20 runs out of power, the primary inductive power module 20 can be charged by a wireless charging device, making the primary inductive power module 20 act as a portable wireless inductive battery. Additionally, the primary inductive power module 20 may further have a solar panel that charges the battery 21, thereby making the device green and friendly to the environment. Besides, the upper cover 31 has its side provided with the socket 311, and the socket 311 is electrically connected to the battery 21, so the battery 21 in the primary inductive power module 20 can be conveniently charged by the grid through a charging cable.

What is claimed is:

1. A pliable object having a low-profile power-coupling transmission module, the pliable object comprising:
a pliable body, having a fixing portion and a receiving pocket that are both at an identical side of the pliable body;
a primary inductive power module, being configured to be placed in the receiving pocket, and having a battery connected to a primary induction coil that has concentric windings and a primary induction patch deposited at one side of the primary induction coil;
a secondary induction module, being flexible and fixed to the fixing portion of the pliable body, and having a secondary induction patch and a secondary induction coil that is deposited at a side of the secondary induction patch and has concentric windings; and
an acting member, being installed on the pliable body and electrically connected to the secondary induction coil;
whereby, when the primary inductive power module is placed in the receiving pocket and is aligned with the secondary induction module, the primary induction coil and the secondary induction coil establish magnetic coupling, which allows power in the battery to be transmitted to the secondary induction coil through the primary induction coil wireless, thereby powering the acting member to function.

2. The pliable object of claim 1, further comprising a casing that has an upper cover and a lower cover, and contains therein the primary inductive power module, wherein a socket is provided at one side of the upper cover and is electrically connected to the battery.

3. The pliable object of claim 1, wherein the pliable body is a pliable object for the secondary induction module, the acting member and the primary inductive power module to install thereon and is selected from the group consisting of a wearable article, a curtain, an umbrella and a tent.

4. The pliable object of claim 1, wherein the acting member is a member driven by electric power and is selected from the group consisting of an LED lamp, sound-giving member, a fan and a sensor.

5. The pliable object of claim 1, wherein the primary induction patch and the secondary induction patch are each a flexible, pliable sheet made of iron powder cement and aluminum.
